(19) United States
(12) Patent Application Publication
(10) Pub. No.: US 2019/0368491 A1
(43) Pub. Date: Dec. 5, 2019

(54) AIR COMPRESSOR

(71) Applicant: DYNA COMPRESSOR CO., LTD., Keelung City (TW)

(72) Inventor: YUN TSAO, Keelung City (TW)

(21) Appl. No.: 15/992,460

(22) Filed: May 30, 2018

(51) Int. Cl. F04C 29/00; F04C 29/02; F16H 7/02; F16H 7/12; F16M 1/04

(52) U.S. Cl. CPC F04C 29/005; F04C 29/02; F16H 7/02; F04C 18/16; F16M 1/04; F04C 2240/30; F16H 7/1281

(57) ABSTRACT

An air compressor has a first plate and a second plate perpendicular to each other, a driving device, a compression assembly, a belt set, and an oil vessel. The driving device is securely mounted on the first plate and comprises a first pulley. A rotating axis of the first pulley is perpendicular to the second plate. The compression assembly is securely mounted on the second plate and comprises a second pulley. A rotating axis of the second pulley is perpendicular to the second plate. The belt set is sleeved on the first pulley and the second pulley. With the driving device and the compression assembly are securely mounted on the first plate and the second plate respectively, the rotating axes of the first pulley and the second pulley may be parallel to each other. Thus, a tension may be distributed on the belt set evenly.

### BACKGROUND OF THE INVENTION

### 1. Field of the Invention

The present invention relates to a compressor, especially to a high precision compressor for compressing air.

### 2. Description of the Prior Arts

Conventional air compressors may be sorted as reciprocating air compressors and rotary-screw air compressors. Structures of the reciprocating air compressor are complicated, components of the reciprocating air compressor may be worn or make noise, and a compression ratio of the reciprocating air compressor is lower. For the above reasons, the rotary-screw air compressors are more widely used compared to the air reciprocating compressors.

A conventional rotary-screw air compressor includes a motor and a compression assembly. The motor and the compression assembly are sleeved and connected to each other by a belt so that power of the motor can be transmitted to the compression assembly and drive the compression assembly to operate and compress air. To drive the compression assembly stably, the belt should be tightly sleeved on the motor and compression assembly. On the other hand, if powers of the motor and compression assembly are large, a strength of the belt must be adequate to transmit power. To increase the strength of the belt, common ways are using a wider belt or using several normal belts so that forces between the motor and the compression assembly are dispersed.

However, if the belt has a broader width or the number of the belts is increased, the force exerted on the belt(s) is hard to be dispersed evenly. Precisely, if a rotating axis of the motor and the rotating axis of the compression assembly are skew to each other rather than parallel with each other, distances between sections of the two rotating axes may be different. Therefore, when the belt is sleeved on the skew rotating axes, different parts of the belt endure different stresses. Or, for an air compressor including a group of belts, each belt may endure a different stress, so that some belts may endure larger stresses and thus deform and stretch, and some belts enduring smaller stresses may slip on the rotating axes of the motor and the compression assembly and thus a wearing speed is increased. Consequently, to make the rotating axes of the motor and the compression assembly parallel with each other, difficulty of assembling the motor and the compression assembly is very high, and time consumption of assembling is large because of repeated calibrating, so production capacity is reduced.

To overcome the shortcomings, the present invention provides an air compressor to mitigate or obviate the aforementioned problems.

### SUMMARY OF THE INVENTION

The main objective of the present invention is to provide an air compressor that has a simple assembling procedure and the accuracy is improved to keep the driving shafts of the driving device and compression assembly in parallel to each other.

The air compressor has a frame, a driving device, a compression assembly, a belt set, an oil vessel. The frame comprises a right-angled base and the right-angled base includes a first plate and a second plate perpendicular to each other. The driving device is securely mounted on the first plate and comprises a first pulley. A rotating axis of the first pulley is perpendicular to the second plate. The compression assembly comprises a compressor and a second pulley. The compressor is securely mounted on the second plate. The second pulley is mounted on a first end of the compressor, and a rotating axis of the second pulley is perpendicular to the second plate. The belt set is sleeved around the first pulley and the second pulley. The oil vessel communicates with the compression assembly.

Therefore, with the right-angled base comprising the first plate and the second plate that are perpendicular to each other, the accuracy of assembling the driving device and the compression assembly is improved. Precisely, because the driving device and the compression assembly are securely mounted on the first plate and the second plate respectively, the driving shaft of the driving device and the driving shaft of the compression assembly are ensured to be parallel with each other, and thereby the rotating axes of the first pulley and the second pulley that are mounted on the driving shafts can keep in parallel with each other. Therefore, the tension on the belt set that is sleeved on the first pulley and the second pulley may distribute evenly on the belt set, and it will not occur that the tension on one part of the belt set is different from that of another part of the belt set in a direction parallel with the rotating axes. With the aforesaid structure, the belt set may not slip and be worn out and thereby a useful lifetime of the belt set is extended. In addition, with the right-angled base, the worker does not need a precision instrument to assist him with locating, adjusting, and calibrating the driving device and the compression assembly during assembly. Instead, the worker may just put the driving device and the compression assembly to abut the right-angled base, fix the driving device and the compression assembly on the right-angled base, and then the assembling is completed. Therefore, even though the worker is not particularly skilled in the assembling, the worker still can finish the assembling with lower error rate and thereby a cost of maintenance is reduced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an air compressor in accordance with the present invention;

FIG. 2 is a front view of the air compressor in FIG. 1;

FIG. 3 is a side view of the air compressor in FIG. 1;

FIG. 4 is an exploded perspective view of a frame, a driving device, a compression assembly, and a belt set of the air compressor in FIG. 1;

FIG. 5 is a perspective view of a right-angled base of the air compressor in FIG. 1;

FIG. 6 is a front view of the right-angled base, the driving device, and the compression assembly of the air compressor in FIG. 1; and

FIG. 7 is a side view of the right-angled base, the driving device, and the compression assembly of the air compressor in FIG. 1.

### DETAILED DESCRIPTION OF THE PREFERRED EMBODIMENTS

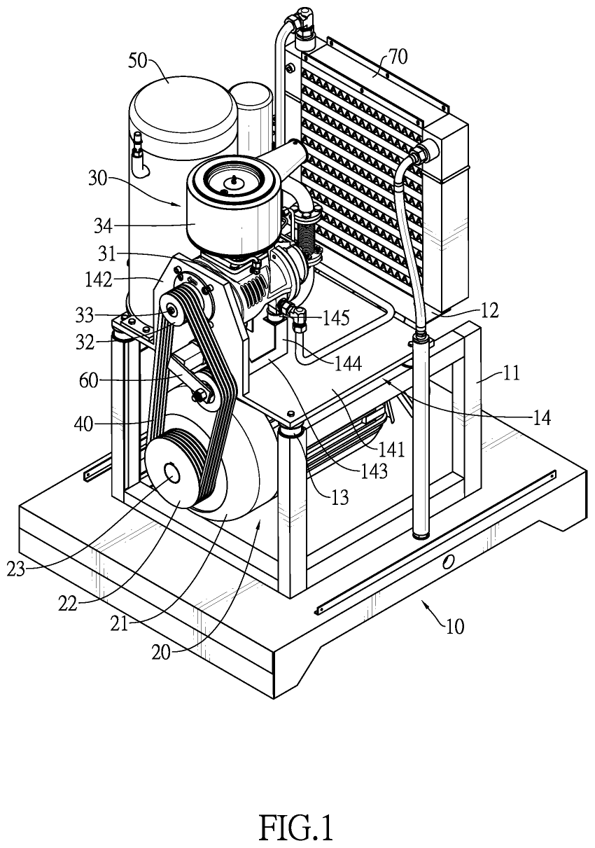

With reference to FIG. 1, an air compressor in accordance with the present invention comprises a frame 10, a driving device 20, a compression assembly 30, a belt set 40, and an oil vessel 50, and selectively comprises a tension adjusting assembly 60 and a cooling assembly 70.

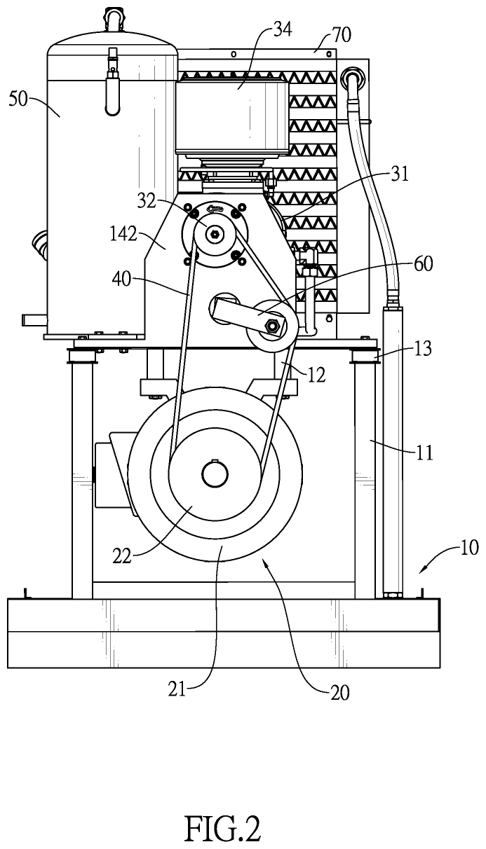

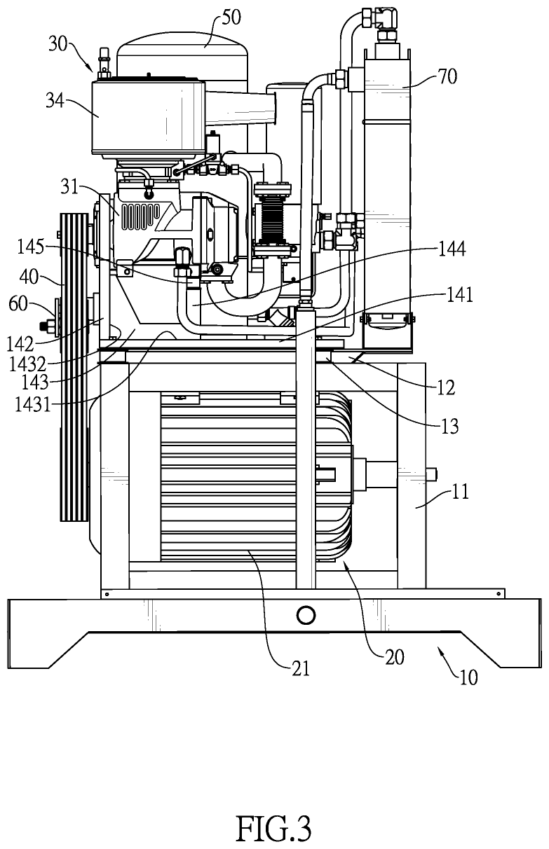

Then please refer to FIGS. 2 to 4. The frame 10 comprises a first support 11, a second support 12, a plurality of second shockproof bumpers 13, and a right-angled base 14.

The first support 11 extends upward and downward, and the second support 12 extends horizontally and is securely mounted on an upper end of the first support 11. The second shockproof bumpers 13 are securely mounted on joints of the first support 11 and the second support 12 so that the second shockproof bumpers 13 are between the first support 11 and the second support 12. Precisely, there are four joints between the first support 11 and the second support 12 in this embodiment, so the number of the second shockproof bumpers 13 is four and the four second shockproof bumpers 13 are mounted on the four joints respectively. Each one of the second shockproof bumpers 13 is elastic to absorb vibration generated by the operating air compressor.

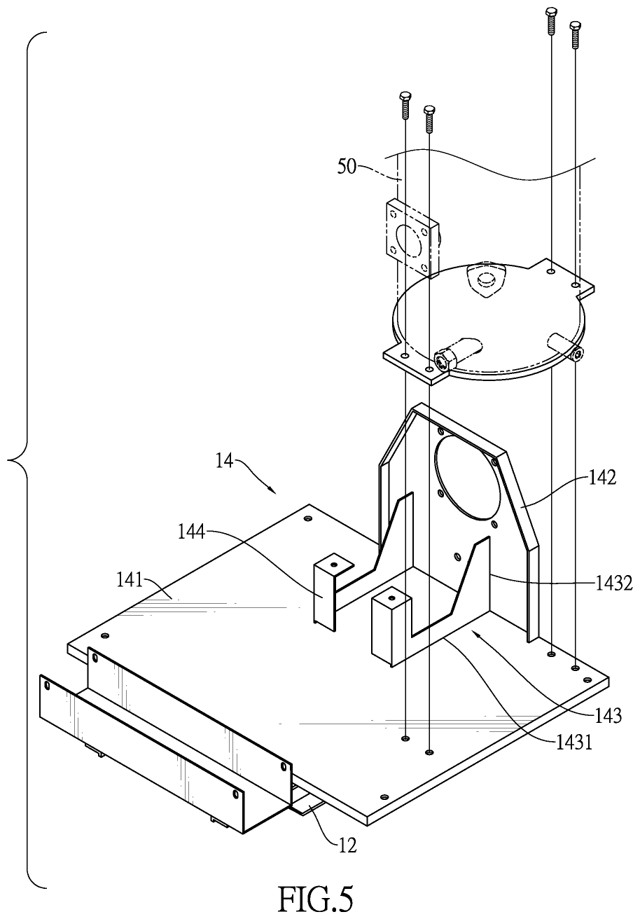

Then please refer to FIGS. 1, 4, and 5. The right-angled base 14 is securely mounted on the second support 12, includes a first plate 141 and a second plate 142, and selectively includes at least one right-angled plate 143, at least one upright column 144, and at least one first shockproof bumper 145. Four corners of the first plate 141 are mounted on the second support 12 and corresponding to the second shockproof bumpers 13 in location. The first plate 141 and the second plate 142 are perpendicular to each other. Precisely, the first plate 141 and the second plate 142 may be made of a metal board through cutting, folding, and punching by automatic machines, and thereby the first plate 141 and the second plate 142 may be made integrally. Because processing automatic machines of metal board is a well-known technique, the processing is in high accuracy and the cost is low. Therefore, with the processing automatic machines, an accuracy of the first plate 141 and the second plate 142 is improved, an angle between the first plate 141 and the second plate 142 is ensured to be a right angle, and through holes on the first plate 141 and the second plate 142 are at correct positions.

Each right-angled plate 143 comprises a first edge 1431 and a second edge 1432. The first edge 1431 abuts and is securely mounted on the first plate 141, and the second edge 1432 abuts and is securely mounted on the second plate 142. Therefore, with the right-angled plates 143, the first plate 141 and the second plate 142 can be kept perpendicular to each other, instead of deforming because of bearing weight for a long period of time.

Each upright column 144 comprises an upper end and a lower end. The lower end of each upright column 144 is securely mounted on the first plate 141. Each first shockproof bumper 145 is securely mounted on the upper end of a respective upright column 144. Precisely, each upright column 144 has a screw at the upper end of the upright column 144 and the first shockproof bumper 145 is screwed on the screw, so that a height position of the first shockproof bumper 145 can be adjusted by rotating. Each upright column 144 is perpendicular to the first plate 141 and extends upward from the first plate 141. The upright column 144 may be a solid column or a hollow column, or a column-like body made from a folded plate.

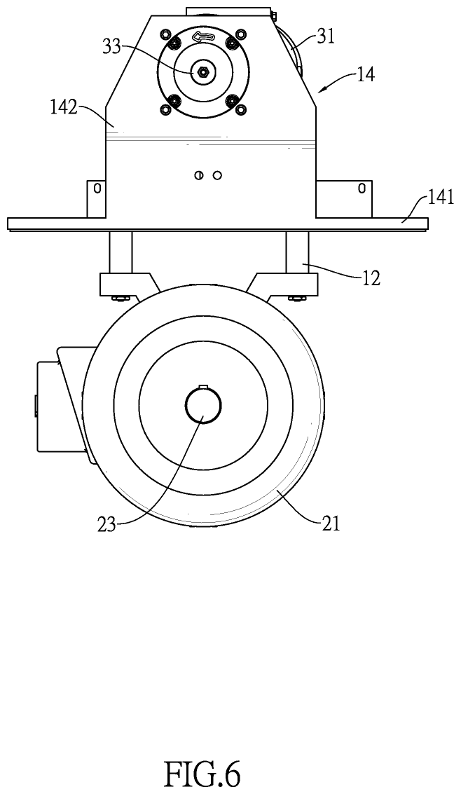

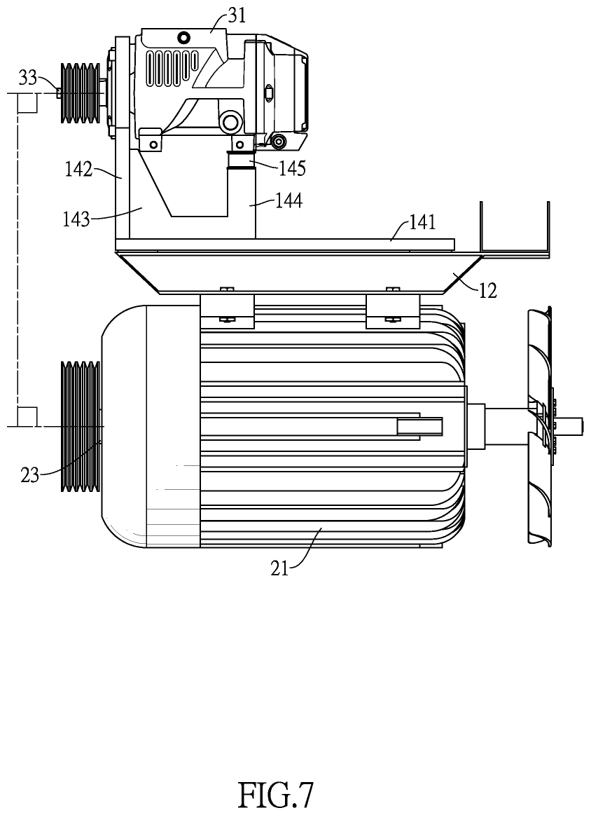

Then please refer to FIGS. 2, 3, 6, and 7. The driving device 20 is securely mounted on the first plate 141 and comprises a motor 21, a first pulley 22, and a driving shaft 23. The motor 21 abuts and is securely mounted on a lower surface of the first plate 141. In other words, an upper surface of the driving device 20 is securely mounted on the lower surface of the first plate 141. Therefore, the driving shaft 23 of the driving device 20 is parallel with the first plate 141. The first pulley 22 is sleeved on the driving shaft 23 of the driving device 20, so that a rotating axis of the first pulley 22 is parallel with the first plate 141. Moreover, the first plate 141 is punched to form the through holes by the automatic machines, and the through holes are arranged for the driving shaft 23 of the driving device 20 to be perpendicular to the second plate 142 (e.g. the through holes may be lined up in a direction perpendicular to the second plate 142). Therefore, after the driving device 20 is fastened in the through holes and fixed on the first plate 141, the driving shaft 23 of the driving device 20 is perpendicular to the second plate 142 accurately and do not need further adjustment.

The compression assembly 30 is securely mounted on the second plate 142. In this embodiment, the compression assembly 30 comprises a compressor 31, a second pulley 32, a driving shaft 33, and selectively comprises an inlet filter device 34. The compressor 31 comprises a first end and a second end that are opposite ends of the compressor 31. An end surface of the first end of the compressor 31 abuts and is securely mounted on the second plate 142. The driving shaft 33 of the compression assembly 30 extends out of the first end of the compressor 31, and the driving shaft 33 of the compression assembly 30 is mounted through and is perpendicular to the second plate 142. The second pulley 32 is sleeved on the driving shaft 33 of the compression assembly 30, so a rotating axis of the second pulley 32 is also perpendicular to the second plate 142.

A bottom surface of the second end of the compressor 31 abuts on the upper end of the upright column 144 for supporting the compression assembly 30, so that the driving shaft 33 of the compression assembly 30 can keep perpendicular to the second plate 142. In this embodiment, the second end of the compressor 31 is securely mounted on the first shockproof bumpers 145 at the upper ends of the upright columns 144. In other words, the first shockproof bumpers 145 are between the compression assembly 30 and the upright column 144. However, the compressor 31 and the first shockproof bumpers 145 are not fixed on each other tightly, each first shockproof bumper 145 upward abuts slightly a bottom surface of the compressor 31 instead, so that the first shockproof bumpers 145 can support the compressor 31 and the driving shaft 33 of the compression assembly 30 may not be oblique. Similar to the second shockproof bumpers 13, the first shockproof bumpers 145 may be elastic to absorb vibration generated by the operating air compressor. Besides, a distance between the compressor 31 and the upright column 144 may be adjusted through adjusting the first shockproof bumpers 145 and thereby keep the driving shaft 33 of the compression assembly 30 perpendicular to the second plate 142.

Then please refer to FIG. 1. The inlet filter device 34 is securely mounted on an upper side of the compressor 31 and communicates with the compressor 31. Therefore, air entering the compressor 31 will be filtered by the inlet filter device 34 for and removing dust or dirt.

The belt set 40 is sleeved on the first pulley 22 and the second pulley 32 and thereby energy generated by the driving device 20 can transmit to the compression assembly 30 via the belt set 40.

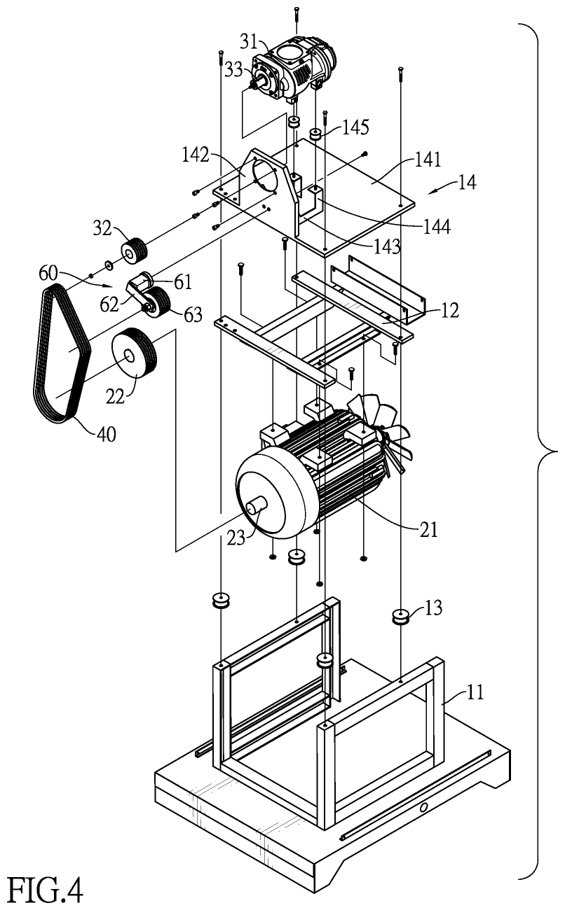

Then please refer to FIGS. 1 and 4. The tension adjusting assembly 60 comprises a torque provider 61, an arm 62, and a wheel 63. The torque provider 61 extends in a direction perpendicular to the second plate 142. The torque provider 61 comprises a fixed end and a free end. The fixed end of the torque provider 61 is securely mounted on the second plate 142. The arm 62 comprises a pivoting end and an abutting end. The pivoting end of the arm 62 is tiltably mounted on the free end of the torque provider 61. The arm 62 is perpendicular to the torque provider 61. In other words, the arm 62 extends in a direction parallel with the second plate 142. The wheel 63 is pivotably mounted on the abutting end of the arm 62, and a rotating axis of the wheel 63 is perpendicular to the arm 62. In other words, the rotating axis of the wheel 63 is also perpendicular to the second plate 142. Thus, the torque provider 61 provides a torque on the arm 62, which makes the wheel 63 keep abutting the belt set 40.

With the tension adjusting assembly 60 keeping abutting the belt set 40, even if the air compressor of the present invention is used for a long term and thus the belt set 40 gets loose, the tension adjusting assembly 60 still can make the belt set 40 have constant tension and adjustment is not needed. Therefore, the first pulley 22 can transmit power to the second pulley 32 stably via the belt set 40 instead of being broken or slipping with respect to the belt set 40.

The oil vessel 50 communicates with the compression assembly 30, or, to be precise, communicates with the compressor 31. The air compressed by the compressor 31 is reserved in the oil vessel 50. The cooling assembly 70 may be used for cooling the compressed air or lubricating oil circulating in the compressor 31.

Consequently, with the right-angled base 14 comprising the first plate 141 and the second plate 142 that are perpendicular to each other, the accuracy of assembling the driving device 20 and the compression assembly 30 is improved. Precisely, because the driving device 20 and the compression assembly 30 are securely mounted on the first plate 141 and the second plate 142 respectively, the driving shaft 23 of the driving device 20 and the driving shaft 33 of the compression assembly 30 are ensured to be parallel with each other, and thereby the rotating axes of the first pulley 22 and the second pulley 32 that are mounted on the driving shafts 22, 33 can keep in parallel with each other. Therefore, the tension on the belt set 40 that is sleeved on the first pulley 22 and the second pulley 32 may distribute evenly on the belt set 40, and it will not occur that the tension on one part of the belt set 40 is different from that of another part of the belt set 40 in a direction parallel with the rotating axes. With aforesaid structure, the belt set 40 may not slip and be worn out and thereby a useful lifetime of the belt set 40 is extended. In addition, with the right-angled base 14, the worker does not need a precision instrument to assist him with locating, adjusting, and calibrating the driving device 20 and the compression assembly 30 during assembly. Instead, the worker may just put the driving device 20 and the compression assembly 30 to abut the right-angled base 14, fix the driving device 20 and the compression assembly 30 on the right-angled base 14, and then the assembling is completed. Therefore, even though the worker is not particularly skilled in the assembly, the worker still can finish the assembly with lower error rate and thereby a cost of maintenance is reduced.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An air compressor comprising:
a frame comprising:
a right-angled base including:
a first plate and a second plate perpendicular to each other;
a driving device securely mounted on the first plate and comprising:
a first pulley, a rotating axis of the first pulley perpendicular to the second plate;
a compression assembly comprising:
a compressor securely mounted on the second plate; and
a second pulley mounted on a first end of the compressor, and a rotating axis of the second pulley perpendicular to the second plate;
a belt set sleeved around the first pulley and the second pulley; and
an oil vessel communicating with the compression assembly.

2. The air compressor as claimed in claim 1, wherein the right-angled base further comprises:
at least one upright column being perpendicular to the first plate; a lower end of each one of the at least one upright column securely mounted on the first plate and an upper end of each one of the at least one upright column securely mounted on a second end of the compressor;
wherein the first end and the second end of the compressor are two opposite ends.

3. The air compressor as claimed in claim 2, wherein the right-angled base further comprises:
at least one first shockproof bumper, each one of the at least one first shockproof bumper mounted on the upper end of a respective one of the at least one upright column and between the compression assembly and said upright column.

4. The air compressor as claimed in claim 1, wherein an upper surface of the driving device is securely mounted on a lower surface of the first plate.

5. The air compressor as claimed in claim 3, wherein an upper surface of the driving device is securely mounted on a lower surface of the first plate.

6. The air compressor as claimed in claim 1, wherein:
the compression assembly further comprises:
a driving shaft mounted in the compressor and extending out of the first end of the compressor;
an end surface of the first end of the compressor abutting the second plate so that the driving shaft is perpendicular to the second plate; and
the second pulley is sleeved on and rotates with respect to the driving shaft;
wherein the end surface of the compression assembly abuts and is securely mounted on the second plate, and the rotating axis of the second pulley is perpendicular to the end surface of the compression assembly.

7. The air compressor as claimed in claim 5, wherein:
the compression assembly further comprises:
a driving shaft mounted in the compressor and extending out of the first end of the compressor;
an end surface of the first end of the compressor abutting the second plate so that the driving shaft is perpendicular to the second plate; and
the second pulley is sleeved on and rotates with respect to the driving shaft;
wherein the end surface of the compression assembly abuts and is securely mounted on the second plate, and the rotating axis of the second pulley is perpendicular to the end surface of the compression assembly.

8. The air compressor as claimed in claim 1, wherein the right-angled base further comprises:
at least one right-angled plate, each one of the at least one right-angled plate having a first edge and a second edge perpendicular to each other; the first edge of each one of the at least one right-angled plate abutting and securely mounted on the first plate and the second edge of each one of the at least one right-angled plate abutting and securely mounted on the second plate.

9. The air compressor as claimed in claim 7, wherein the right-angled base further comprises:
at least one right-angled plate, each one of the at least one right-angled plate having a first edge and a second edge perpendicular to each other; the first edge of each one of the at least one right-angled plate abutting and securely mounted on the first plate and the second edge of each one of the at least one right-angled plate abutting and securely mounted on the second plate.

10. The air compressor as claimed in claim 1 further comprising a tension adjusting assembly, the tension adjusting assembly comprising:
a torque provider having a fixed end and a free end, the fixed end securely mounted on the second plate, and the torque provider extending in a direction that is perpendicular to the second plate;
an arm having a pivoting end and an abutting end; the pivoting end tiltably mounted on the free end of the torque provider and the arm extending in a direction that is parallel with the second plate; and
a wheel rotatably mounted on the abutting end of the arm, and a rotating axis of the wheel being perpendicular to the second plate;
wherein the torque provider forces the arm so that the wheel on the arm keeps abuts the belt set.

11. The air compressor as claimed in claim 9 further comprising a tension adjusting assembly, the tension adjusting assembly comprising:
a torque provider having a fixed end and a free end, the fixed end securely mounted on the second plate, and the torque provider extending in a direction that is perpendicular to the second plate;
an arm having a pivoting end and an abutting end; the pivoting end tiltably mounted on the free end of the torque provider and the arm extending in a direction that is parallel with the second plate; and
a wheel rotatably mounted on the abutting end of the arm, and a rotating axis of the wheel being perpendicular to the second plate;
wherein the torque provider forces the arm so that the wheel on the arm keeps abuts the belt set.

12. The air compressor as claimed in claim 1, wherein the frame further comprises:
a first support extending upward and downward; and
a second support extending horizontally and securely mounted on an upper end of the first support; the right-angled base securely mounted on the second support.

13. The air compressor as claimed in claim 11, wherein the frame further comprises:
a first support extending upward and downward; and
a second support extending horizontally and securely mounted on an upper end of the first support; the right-angled base securely mounted on the second support.

14. The air compressor as claimed in claim 12, wherein the frame further comprises:
a plurality of second shockproof bumpers securely mounted on joints of the first support and the second support and between the first support and the second support.

15. The air compressor as claimed in claim 13, wherein the frame further comprises:
a plurality of second shockproof bumpers securely mounted on joints of the first support and the second support and between the first support and the second support.
